(19) United States
(12) Patent Application Publication
(10) Pub. No.: US 2011/0121604 A1
(43) Pub. Date: May 26, 2011

(54) Safety-Lift RV Cover and Tarp Installer

(76) Inventor: Frank Martin Drao, Placerville, CA (US)

(21) Appl. No.: 12/870,178

(22) Filed: Aug. 27, 2010

Related U.S. Application Data
(60) Provisional application No. 61/237,914, filed on Aug. 28, 2009.

(51) Int. Cl. B60J 11/00

(52) U.S. Cl. 296/98

(57) ABSTRACT

A manually operated device designed to securely grip onto an RV cover or tarp, span the width of the RV and with the aid of two telescoping handles allow said cover to be safely raised up to a height sufficient to allow the cover or tarp to be installed over the RV, motor home, travel trailer, fifth wheel trailer or boat allowing the unit to be covered safely from the ground, eliminating the inherent risks with climbing upon it.

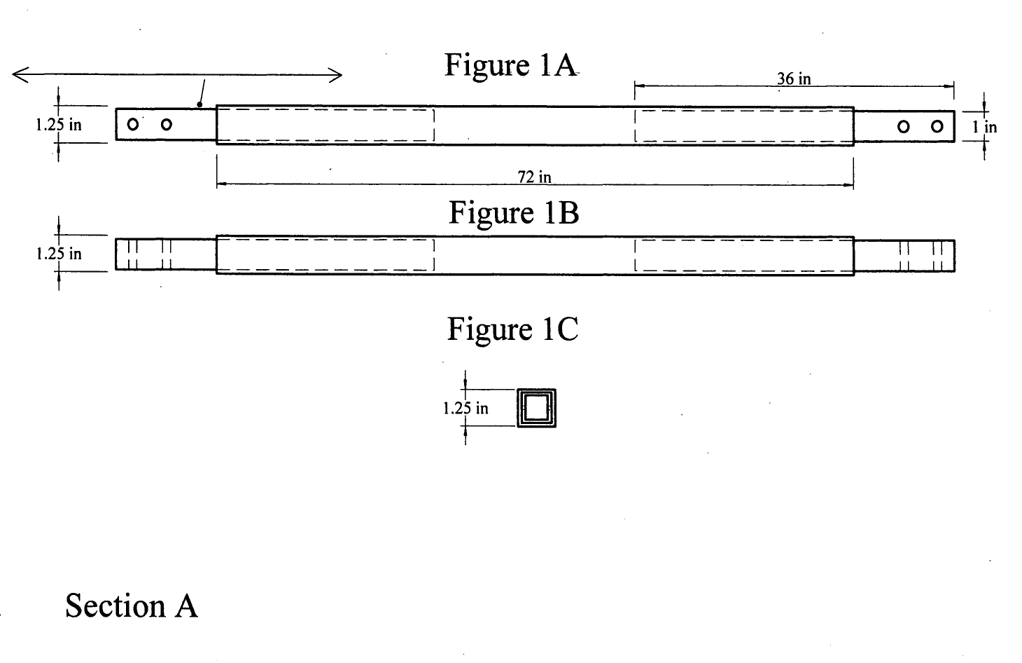

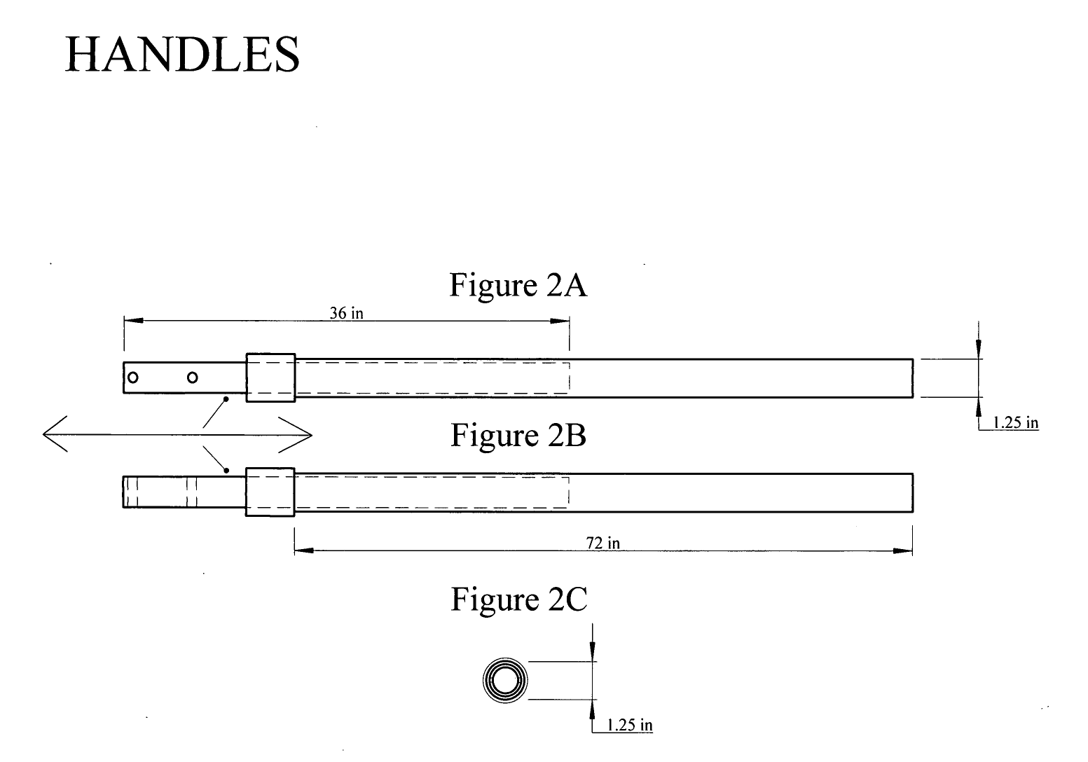

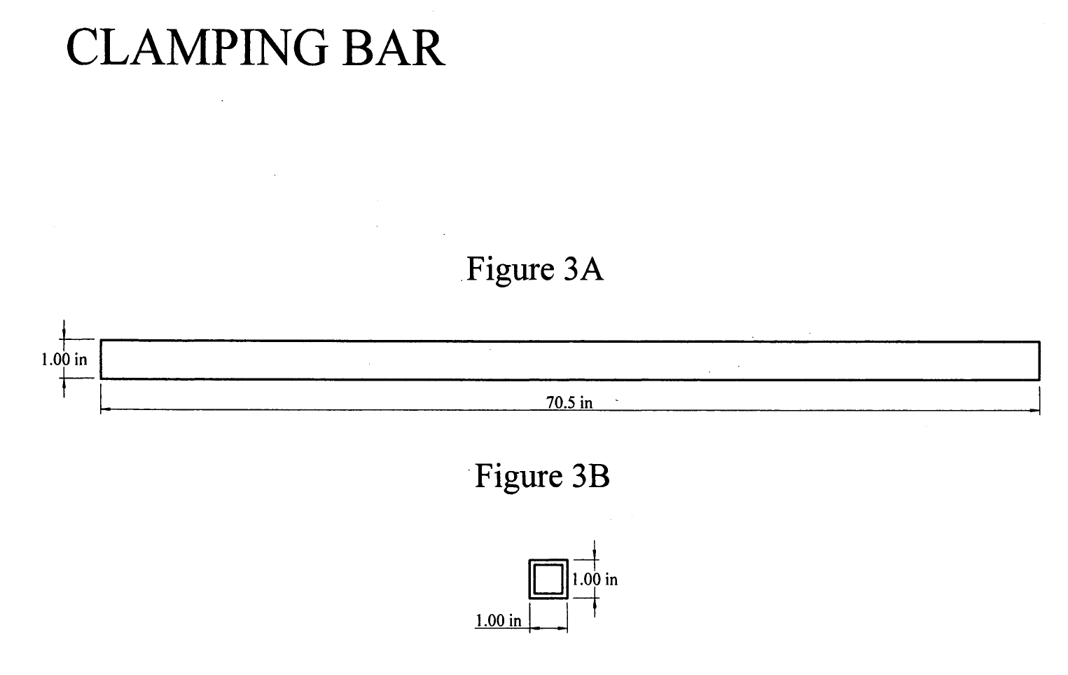

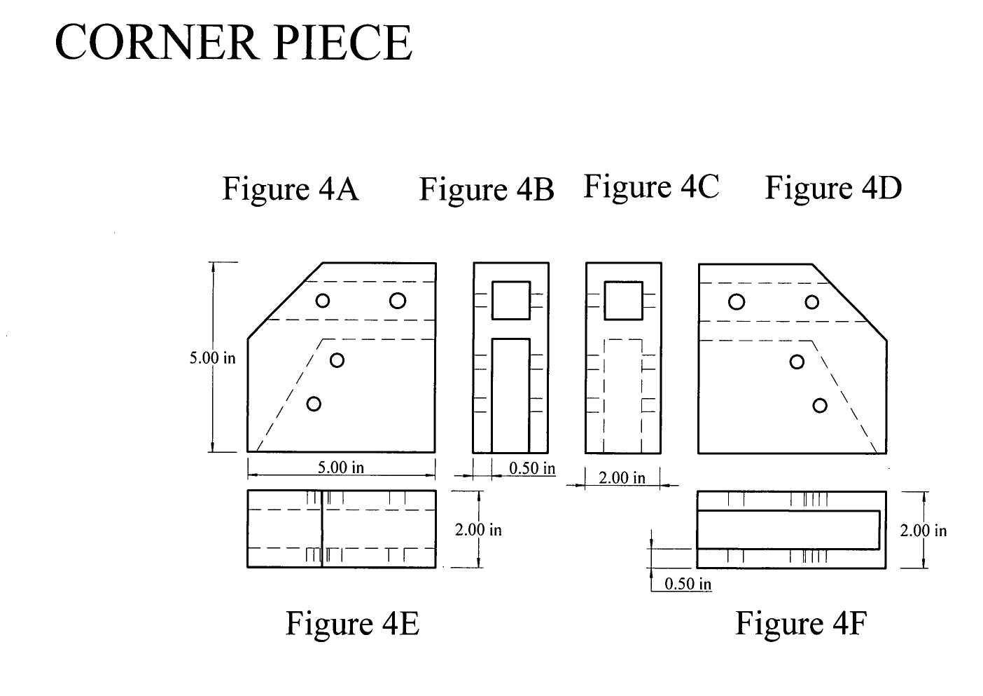

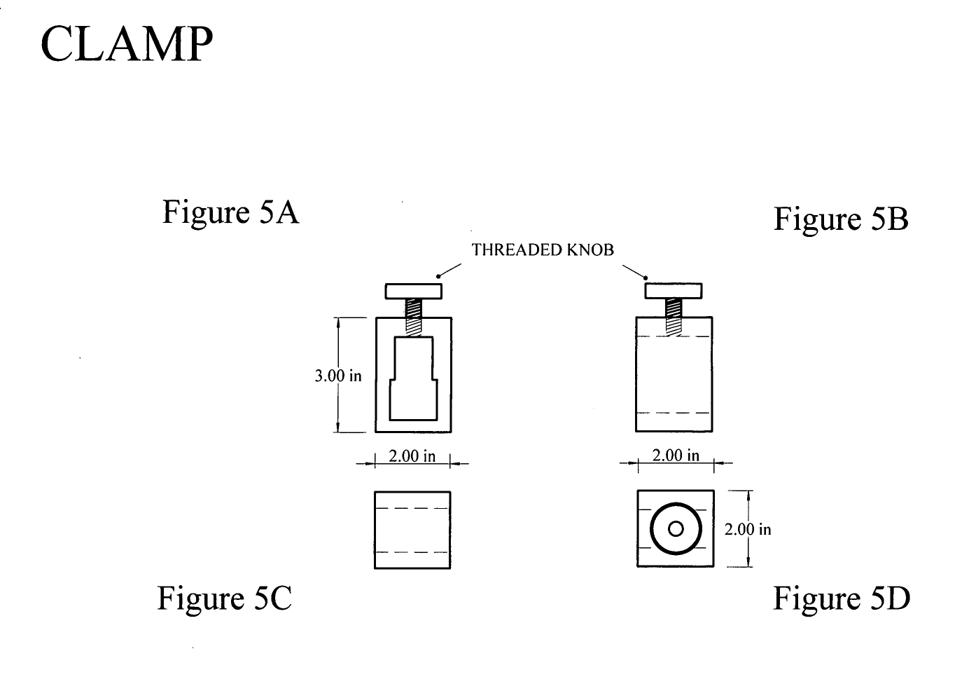

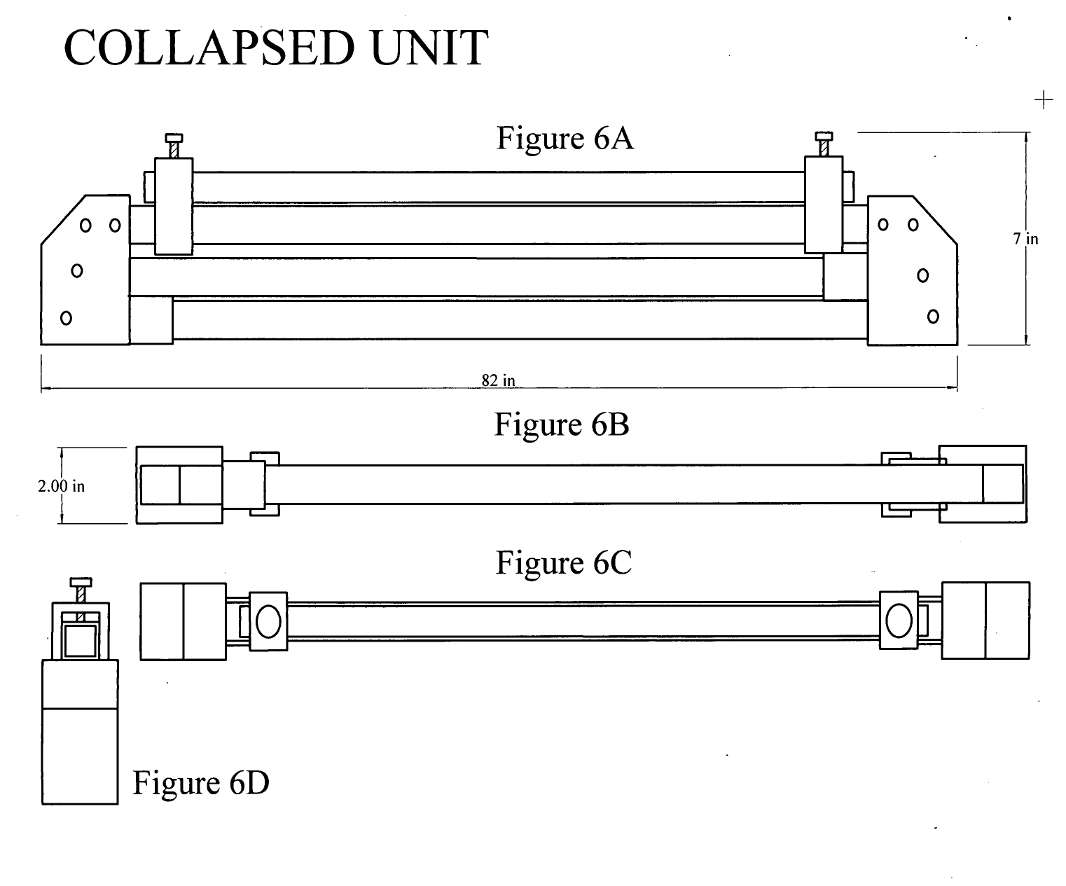

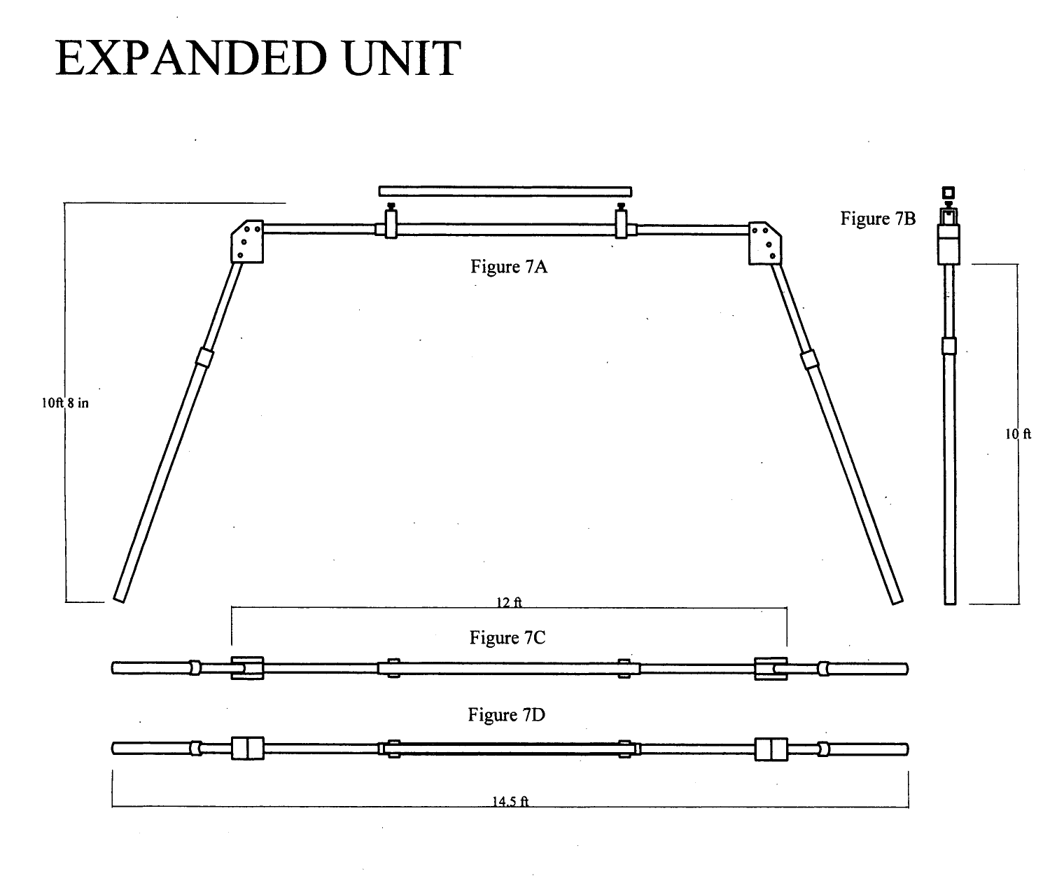

### CROSS-REFERENCE TO RELATED APPLICATIONS

This application claims the benefit of provisional patent application No. 61/237,914 filed Aug. 28, 2009 by the present inventor

### FEDERALLY SPONSORED RESEARCH

Not Applicable

### SEQUENCE LISTING OR PROGRAM

Not Applicable

### BACKGROUND

1. Field

This application relates to RV covers, boat covers, equipment covers and tarps, specifically to their installation.

2. Prior Art

To the best of this inventor's knowledge no such comparable device has been developed, invented or placed in use. It was the failure of the inventor to find such a device for his personal use that spawned the inspiration for this device.

At the present time owner's of recreational vehicles, trailers, motor homes and fifth wheel trailers that wish to cover them with a commercially sold cover or tarp, must either climb up on top of them risking damage to the vehicle as well as personal injury or employ the use of two step ladders and various makeshift poles to accomplish this goal. The current methods of installation of such covers as described on the web-sites of cover retailers, potentially exposes the installer to personal injury caused, by falling off ladders, tripping and falling while navigating over, around and between the numerous projections and obstacles mounted on the roof of a recreational vehicle, motor home, travel trailer, or fifth wheel trailer.

The installer is also exposed to the risk of a back injury while attempting to carry a commercially available cover or tarp which may weigh as much as 75 to 80 lbs., up to the top of a recreational vehicle, motor home, travel trailer, or fifth wheel trailer.

Risk of property damage is also a very real danger as currently prescribed methods of installing RV covers involves but is not limited to the use of sticks, throw-bags, ropes and other make-shift items.

This device is designed to eliminate the need to climb up on the roof or employ any ladders or make-shift devices, thus eliminating the potential dangers inherent in such activities.

With the aid of one embodiment of the Safety-lift RV cover and tarp installer a commercially available cover or tarp can be installed over a recreational vehicle, motor home, travel trailer, or fifth wheel trailer. In fact the device can be used to also cover a boat or any other large stationary object such as stacks of building materials or agricultural goods without having to climb upon them, walk on top of them or otherwise risk damaging them or exposing themselves to the risk of physical injury.

One embodiment of the Safety-lift RV cover and tarp installer allows the user to raise and support a commercially available cover or tarp high enough to pass the cover over the top of the a recreational vehicle, motor home, travel trailer, fifth wheel trailer, boat or any other large stationary object such as stacks of building materials or agricultural goods while the installers remain safely and firmly on the ground.

### SUMMARY

At present there is no device commercially available that is designed to safely install a cover over a recreational vehicle, motor home, travel trailer or fifth wheel trailer. This device is designed to make installing a cover or tarp as safe and as easy as possible.

### DRAWINGS

Page 1, shows main frame or top. Three pieces shown

Page 2, Shows the telescoping handles

Page 3, shows clamping bar

Page 4, shows the corners which hold the handles and main frame together

Page 5, Shows clamps used to apply pressure to clamping bar

Page 6, shows assembled unit in collapsed configuration

Page 7, shows assembled unit fully opened for use

### DETAILED DESCRIPTION

One embodiment of the Safety-lift RV cover and tarp installer consists of the following parts, while the sizes, shapes and materials listed apply to this one embodiment, I contemplate that other cross sections, sizes and types of materials could work equally as well.

In this one embodiment there are 4 major components, a top section, (main frame), two telescoping handles and a clamping device. Small parts include corner brackets, various nuts, bolts and pins as required to assemble the unit see drawings pages 1 thru 7.

The main frame is designed to span the top of a recreational vehicle, travel trailer or fifth wheel trailer. The main frame in this embodiment consists of three components. A center section 6 foot in length and two end sections 3 feet in length that slide into the ends of the center section see drawing page 1.

### Main Frame

The main frame consists of three sections of square tubing. The center section in this one embodiment is made from square aluminum tube 72 inches long with an outside dimension of 1.25 inches and a wall thickness of 0.058 inches. Other suitable materials, (composites, thin wall steel, etc.), dimensions and cross sections could work equally as well. The center section has four 0.30 inch holes in it, 2 holes spaced 3 inches from each end and 2 holes spaced 29 inches from each end. These holes exist to accept spring loaded pushbutton latches contained within the two outer ends. The purpose of the holes and latches in this one embodiment is to hold the main frame in either the open or closed positions. The spacing and hole size could be altered in other contemplated configurations. A pair of rectangular clamps will be slid over the center section during assembly see drawing page 5

The sliding ends in this embodiment are made of square aluminum tubing with an outside dimension of 1 inch and a wall thickness of 0.049 inches although other cross sections, materials and dimensions could be employed in alternate embodiments. These tubes would have a total of 3, 0.30 inch holes in them spaced as follows; 1 hole 3 inches from one end and on the opposite end of the tube there would be 1 hole 0.5 inches from the end and a second hole spaced 3.25 inches from the end. These holes could be different dimensions and in different locations in alternate embodiments. These holes allow the unit to be lock in either the open or closed position

### Corner Brackets

Attached to the main frame in this embodiment are corner brackets machined in two pieces from HDPE plastic material see page 4 of drawings. Other configurations for the corners include but are not limited to injection molded composites, cast metals or welded metals. In this embodiment the corners are machined so that when the two halves are put together they form a 1 inch square channel through the top portion which will allow the main frame extensions to be attached. The corners also form a channel of sufficient size to allow the handles to be attached and pivot approximately 270 degrees allowing them to be opened and closed. Other configurations are contemplated. The corners have a series of holes drilled in them to allow attachment and operation of the handles.

### Clamping Bar

The clamping bar in this embodiment consists of a 70.5 inch long by 1 inch square aluminum tube with a 0.049 wall thickness see page 3 of drawings. Other cross-sections, dimensions and materials may be used in other configurations. The clamping bar would be attached by sliding it through the clamps see page 6 of drawings attached to the center section of the main frame and secured with two thumb screws.

### Handles

The handles in this one embodiment are made from two pieces of round aluminum tubing. Other suitable materials, cross-sections and dimensions could be applied in other contemplated configurations. In this embodiment the outer tube has and outside diameter of 1.25 inches with a wall thickness of 0.058 and a total length of 72 inches. Each of these tubes would have two 0.30 inch holes in them. One of the holes would be located 0.5 inches from one end while the second hole would be 6 inches from the opposite end. The inner tube would have an outside diameter of 1 inch a wall thickness of 0.049 and an overall length of 72 inches. Each of the inner tubes would have 4, 0.30 inch holes in them, one 6 inches from one end of the tube and the remaining three would be positioned at the opposite end of the tube in the following positions, 0.375 from the end, 2 inches from the end and 3.3125 from the end. The use of other configurations as well as the use of commercially available extension poles have been and continue to be contemplated. The handles would be attached to the corner brackets by a single nut and bolt allowing them to pivot. This embodiment allows the device to be folded in on itself for storage.

### Operation

The Safety-lift RV cover and tarp installer is operated in the following manner. This embodiment of the device is positioned on the ground at either end of the recreational vehicle, travel trailer, fifth wheel trailer or other item to be covered in the folded position with the clamping bar on top. The cover is folded into a fan fold configuration and placed on the ground between the Safety-lift RV cover and tarp installer and the vehicle to be covered. The front edge of the cover is pulled through the space between the clamping bar and top of the main frame, (approximately 4 to 6 feet of the material). The two thumb screws are tightened applying pressure to the clamping bar and capturing the cover between the clamping bar and mainframe. Next the handles are pulled to the open position until the spring buttons lock them in place. The handles are then fully extended and secured. With the cover clamped in place it is then simply a matter of two people each taking a handle and raising the cover up above the roof line of the vehicle being covered and walking to the opposite end of the vehicle thus deploying the cover. The Safety-lift RV cover and tarp installer is then simply laid on the ground the clamping bar is loosened and then the front edge of the cover is removed from the clamp. Simply reversing the process allows for easy cover removal as well.

### Conclusion, Ramification and Scope

Accordingly the reader can see that the use of this one embodiment allows for a quicker safer method of installing an RV cover or tarp eliminating the necessity of ladders or climbing up on the roof. This eliminates:

The risk of injury to the installer associated with the possibility of falling that is inherent any time something is climbed on.

The risk of damage to the Recreational vehicle, motor home, travel trailer, or fifth wheel trailer associated with walking on the roof (not recommended by any manufacturer)

The risk of damage to the Recreational vehicle, motor home, travel trailer or fifth wheel trailer associated with the use of step ladders placed in very close proximity to the sides of the vehicle.

This one embodiment as well as it's variations has application beyond the RV industry. Construction, covering stacks of building materials, large tools, equipment Agricultural, covering feed, hay etc. Covering harvested fruits, grain, etc Transportation, covering any load.

I claim:

1. A handheld manually operated RV cover and tarp installer comprising:
a) a main frame to span the width of the top of any commercially available RV
b) a clamp attached to the main frame to secure an RV cover or tarp securely in place
c) folding and telescoping handles sufficient in length to clear the highest point of any commercially available RV.

2. the components of said RV cover and tarp installer shall be composed of a suitably strong and light weight material

3. the main frame of claim 1 shall consist of a solid center section constructed of 1.25 inch square aluminum tubing, two end sections which slide into the center section to facilitate the expansion and contraction of said main frame

4. the end sections of said mainframe shall each be fitted with a corner bracket of HDPE composite machined or molded to attach the mainframe to the handles

5. the clamp of claim 1 shall be a 0.75 inch square aluminum tube 70.5 inches in length attached to the mainframe with two clamps of the same HDPE material as used in the corners

6. the handles of claim 1 shall be two pieces of telescopic tubing capable of closing to a minimum of 6 feet and extended to a maximum of 11 feet

7. the handles in claim 1 shall be attached to the corners in a manner that allows them to be folded in for purposes of storage
